(19) United States
(12) Patent Application Publication
(10) Pub. No.: US 2024/0113888 A1
(43) Pub. Date: Apr. 4, 2024

(54) POST-QUANTUM LATTICE-BASED SIGNATURE LATENCY REDUCTION

(71) Applicant: Intel Corporation, Santa Clara, CA (US)

(72) Inventors: ZACHARY PEPIN, Ann Arbor, MI (US); SANTOSH GHOSH, Hillsboro, OR (US); MANOJ SASTRY, Portland, OR (US)

(73) Assignee: Intel Corporation, Santa Clara, CA (US)

(21) Appl. No.: 17/936,049

(22) Filed: Sep. 28, 2022

(51) Int. Cl. H04L 9/32

(52) U.S. Cl. CPC H04L 9/3247; H04L 9/3271

(57) ABSTRACT

In one example an apparatus comprises processing circuitry to measure a statistical distance between a marginal distribution of a coordinate of a potential signature (z) over a first interval and a uniform distribution over the first interval and use the statistical distance to determine one or more thresholds of a rejection sampling operation in a lattice-based digital signature algorithm. Other examples may be described.

### BACKGROUND

Subject matter described herein relates generally to the field of computer security and more particularly to post-quantum lattice-based signature latency reduction.

Existing public-key digital signature algorithms such as Rivest-Shamir-Adleman (RSA) and Elliptic Curve Digital Signature Algorithm (ECDSA) are anticipated not to be secure against brute-force attacks based on algorithms such as Shor's algorithm using quantum computers. As a result, there are efforts underway in the cryptography research community and in various standards bodies to define new standards for algorithms that are secure against quantum computers.

Accordingly, techniques to accelerate post-quantum lattice-based signature and verification schemes may find utility, e.g., in computer-based communication systems and methods.

### BRIEF DESCRIPTION OF THE DRAWINGS

The detailed description is described with reference to the accompanying figures.

FIGS. 1A and 1B are schematic illustrations of a one-time hash-based signatures scheme and a multi-time hash-based signatures scheme, respectively.

FIGS. 2A-2B are schematic illustrations of a one-time signature scheme and a multi-time signature scheme, respectively.

FIG. 3 is a schematic illustration of a signing device and a verifying device, in accordance with some examples.

FIG. 4A is a schematic illustration of a Merkle tree structure, in accordance with some examples.

FIG. 4B is a schematic illustration of a Merkle tree structure, in accordance with some examples.

FIG. 5 is a schematic illustration of a compute blocks in an architecture to implement a signature algorithm, in accordance with some examples.

FIG. 6A is a schematic illustration of a compute blocks in an architecture to implement signature generation in a signature algorithm, in accordance with some examples.

FIG. 6B is a schematic illustration of a compute blocks in an architecture to implement signature verification in a verification algorithm, in accordance with some examples.

FIG. 7 is a schematic illustration of distributions of components of a digital signature, in accordance with some examples.

FIG. 8 is a flowchart illustrating operations in a method to implement post-quantum lattice-based signature latency reduction, in accordance with some examples.

FIG. 9 is a schematic illustration of a computing architecture which may be adapted to implement post-quantum lattice-based signature latency reduction, in accordance with some examples.

### DETAILED DESCRIPTION

Described herein are exemplary systems and methods to implement post-quantum lattice-based signature latency reduction. In the following description, numerous specific details are set forth to provide a thorough understanding of various examples. However, it will be understood by those skilled in the art that the various examples may be practiced without the specific details. In other instances, well-known methods, procedures, components, and circuits have not been illustrated or described in detail so as not to obscure the examples.

### Post-Quantum Cryptography Overview

Post-Quantum Cryptography (also referred to as “quantum-proof”, “quantum-safe”, “quantum-resistant”, or simply “PQC”) takes a futuristic and realistic approach to cryptography. It prepares those responsible for cryptography as well as end-users to know the cryptography is outdated; rather, it needs to evolve to be able to successfully address the evolving computing devices into quantum computing and post-quantum computing.

It is well-understood that cryptography allows for protection of data that is communicated online between individuals and entities and stored using various networks. This communication of data can range from sending and receiving of emails, purchasing of goods or services online, accessing banking or other personal information using websites, etc.

Conventional cryptography and its typical factoring and calculating of difficult mathematical scenarios may not matter when dealing with quantum computing. These mathematical problems, such as discrete logarithm, integer factorization, and elliptic-curve discrete logarithm, etc., are not capable of withstanding an attack from a powerful quantum computer. Although any post-quantum cryptography could be built on the current cryptography, the novel approach would need to be intelligent, fast, and precise enough to resist and defeat any attacks by quantum computers

Today's PQC is mostly focused on the following approaches: 1) hash-based cryptography based on Merkle's hash tree public-key signature system of 1979, which is built upon a one-message-signature idea of Lamport and Diffie; 2) code-based cryptography, such as McEliece's hidden-Goppa-code public-key encryption system; 3) lattice-based cryptography based on Hoffstein-Pipher-Silverman public-key-encryption system of 1998; 4) multivariate-quadratic equations cryptography based on Patarin's HFE public-key-signature system of 1996 that is further based on the Matumoto-Imai proposal; 5) supersingular elliptical curve isogeny cryptography that relies on supersingular elliptic curves and supersingular isogeny graphs; and 6) symmetric key quantum resistance.

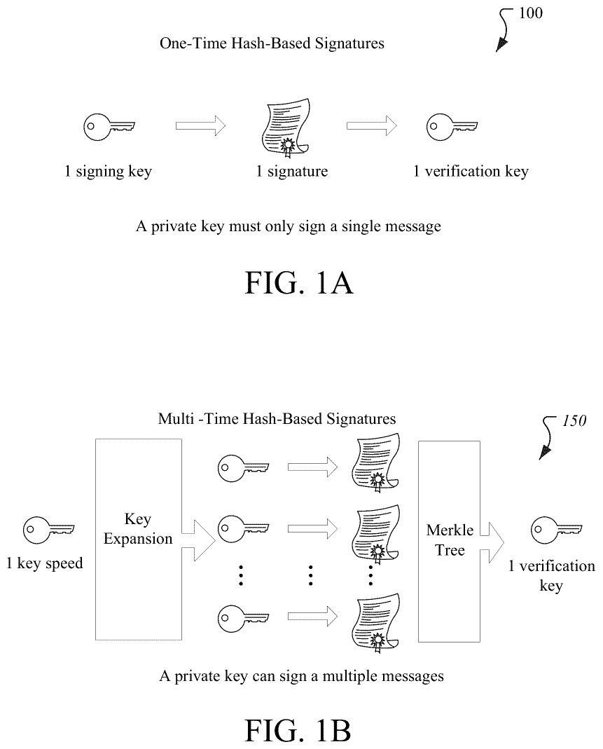

FIGS. 1A and 1B illustrate a one-time hash-based signatures scheme and a multi-time hash-based signatures scheme, respectively. As aforesaid, hash-based cryptography is based on cryptographic systems like Lamport signatures, Merkle Signatures, extended Merkle signature scheme (XMSS), and SPHINCs scheme, etc. With the advent of quantum computing and in anticipation of its growth, there have been concerns about various challenges that quantum computing could pose and what could be done to counter such challenges using the area of cryptography.

One area that is being explored to counter quantum computing challenges is hash-based signatures (HBS) since these schemes have been around for a long while and possess the necessarily basic ingredients to counter the quantum counting and post-quantum computing challenges. HBS schemes are regarded as fast signature algorithms working with fast platform secured-boot, which is regarded as the most resistant to quantum and post-quantum computing attacks.

For example, as illustrated with respect to FIG. 1A, a scheme of HBS is shown that uses Merkle trees along with a one-time signature (OTS) scheme 100, such as using a private key to sign a message and a corresponding public key to verify the OTS message, where a private key only signs a single message.

Similarly, as illustrated with respect to FIG. 1B, another HBS scheme is shown, where this one relates to multi-time signatures (MTS) scheme 150, where a private key can sign multiple messages.

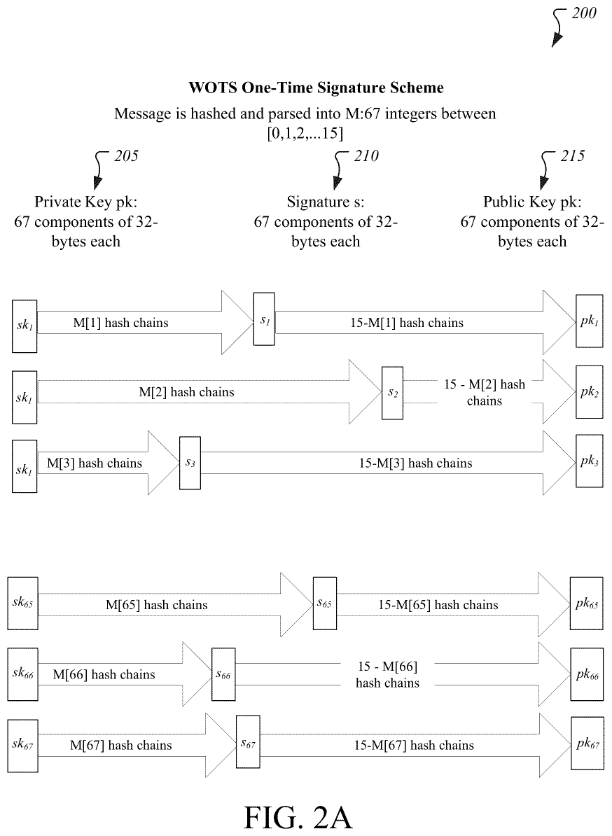

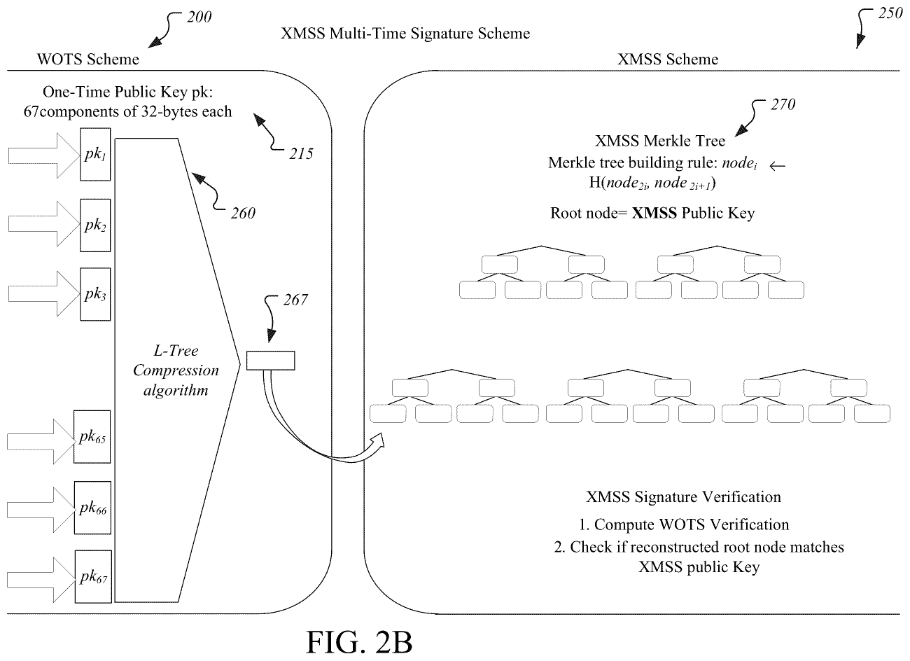

FIGS. 2A and 2B illustrate a one-time signature scheme and a multi-time signature scheme, respectively. Continuing with HBS-based OTS scheme 100 of FIG. 1A and MTS scheme 150 of FIG. 1B, FIG. 2A illustrates Winternitz OTS scheme 200, which was offered by Robert Winternitz of Stanford Mathematics Department publishing as hw(x) as opposed to h(x)lh(y), while FIG. 2B illustrates XMSS MTS scheme 250, respectively.

For example, WOTS scheme 200 of FIG. 2A provides for hashing and parsing of messages into M, with 67 integers between [0, 1, 2, . . . , 15], such as private key, sk, 205, signature, s, 210, and public key, pk, 215, with each having 67 components of 32 bytes each.

FIG. 2B illustrates XMSS MTS scheme 250 that allows for a combination of WOTS scheme 200 of FIG. 2A and XMSS scheme 255 having XMSS Merkle tree. As discussed previously with respect to FIG. 2A, WOTs scheme 200 is based on a one-time public key, pk, 215, having 67 components of 32 bytes each, that is then put through L-Tree compression algorithm 260 to offer WOTS compressed pk 265 to take a place in the XMSS Merkle tree of XMSS scheme 255. It is contemplated that XMSS signature verification may include computing WOTS verification and checking to determine whether a reconstructed root node matches the XMSS public key, such as root node=XMSS public key.

### Accelerators for Post-Quantum Cryptography

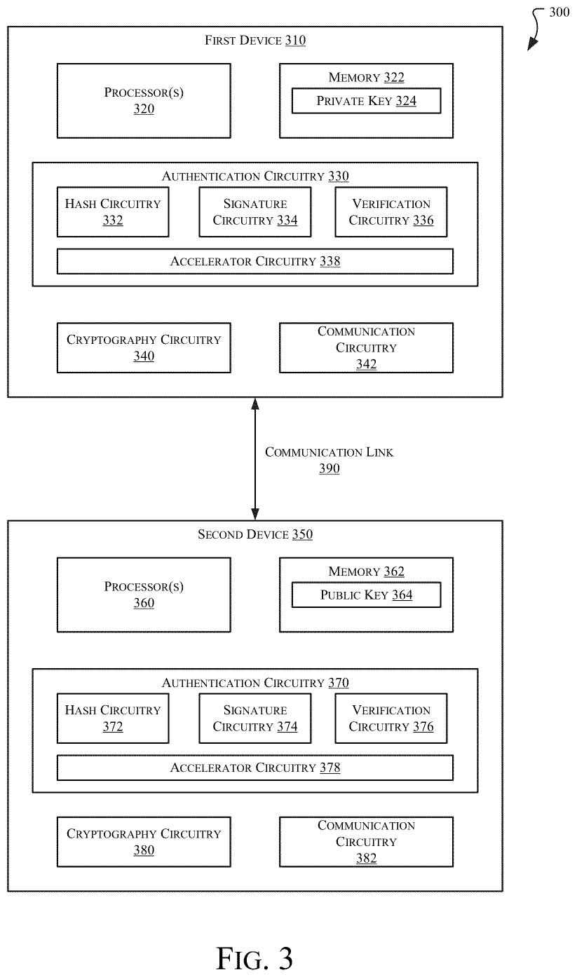

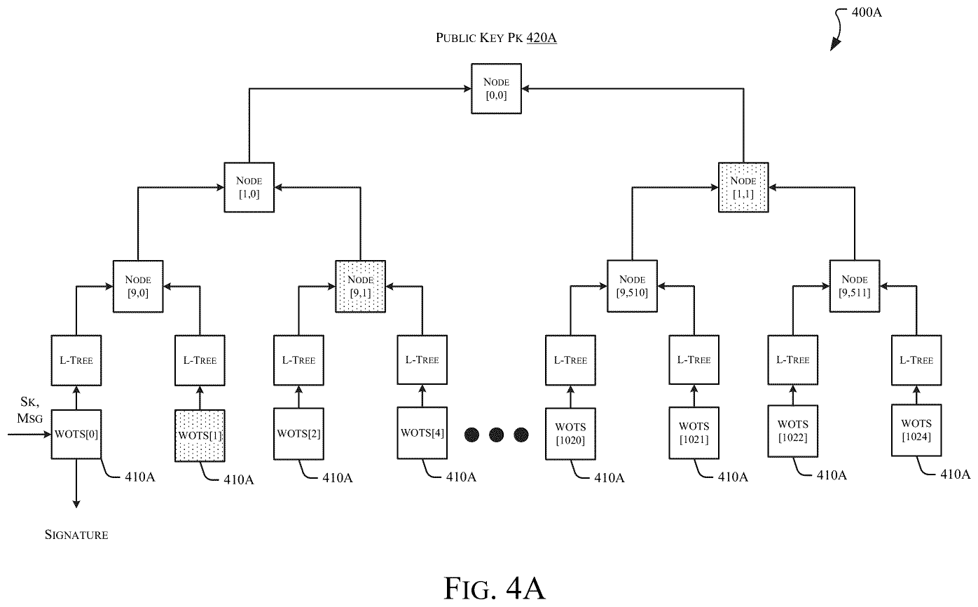

FIG. 3 is a schematic illustration of a high-level architecture of a secure environment 300 that includes a first device 310 and a second device 350, in accordance with some examples. Referring to FIG. 3, each of the first device 310 and the second device 350 may be embodied as any type of computing device capable of performing the functions described herein. For example, in some embodiments, each of the first device 310 and the second device 350 may be embodied as a laptop computer, tablet computer, notebook, netbook, Ultrabook™, a smartphone, cellular phone, wearable computing device, personal digital assistant, mobile Internet device, desktop computer, router, server, workstation, and/or any other computing/communication device.

First device 310 includes one or more processor(s) 320 and a memory 322 to store a private key 324. The processor(s) 320 may be embodied as any type of processor capable of performing the functions described herein. For example, the processor(s) 320 may be embodied as a single or multi-core processor(s), digital signal processor, microcontroller, or other processor or processing/controlling circuit. Similarly, the memory 322 may be embodied as any type of volatile or non-volatile memory or data storage capable of performing the functions described herein. In operation, the memory 322 may store various data and software used during operation of the first device 310 such as operating systems, applications, programs, libraries, and drivers. The memory 322 is communicatively coupled to the processor(s) 320. In some examples the private key 324 may reside in a secure memory that may be part memory 322 or may be separate from memory 322.

First device 310 further comprises authentication circuitry 330 which includes memory 332, signature circuitry, and verification circuitry 336. Hash circuitry 332 is configured to hash (i.e., to apply a hash function to) a message (M) to generate a hash value (m′) of the message M. Hash functions may include, but are not limited to, a secure hash function, e.g., secure hash algorithms SHA2-256 and/or SHA3-256, etc. SHA2-256 may comply and/or be compatible with Federal Information Processing Standards (FIPS) Publication 180-4, titled: “Secure Hash Standard (SHS)”, published by National Institute of Standards and Technology (NIST) in March 2012, and/or later and/or related versions of this standard. SHA3-256 may comply and/or be compatible with FIPS Publication 202, titled: “SHA-3 Standard: Permutation-Based Hash and Extendable-Output Functions”, published by NIST in August 2015, and/or later and/or related versions of this standard.

Signature circuitry 332 may be configured to generate a signature to be transmitted, i.e., a transmitted signature and/or to verify a signature. In instances in which the first device 310 is the signing device, the transmitted signature may include a number, L, of transmitted signature elements with each transmitted signature element corresponding to a respective message element. For example, for each message element, mᵢ, signature circuitry 332 may be configured to perform a selected signature operation on each private key element, sₖᵢ of the private key, sₖ, a respective number of times related to a value of each message element, mᵢ included in the message representative m′. For example, signature circuitry 332 may be configured to apply a selected hash function to a corresponding private key element, sₖᵢ, mᵢ times. In another example, signature circuitry 332 may be configured to apply a selected chain function (that contains a hash function) to a corresponding private key element, sₖᵢ, mᵢ times. The selected signature operations may, thus, correspond to a selected hash-based signature scheme.

Hash-based signature schemes may include, but are not limited to, a Winternitz (W) one time signature (OTS) scheme, an enhanced Winternitz OTS scheme (e.g., WOTS+), a Merkle many time signature scheme, an extended Merkle signature scheme (XMSS) and/or an extended Merkle multiple tree signature scheme (XMSS-MT), etc. Hash functions may include, but are not limited to SHA2-256 and/or SHA3-256, etc. For example, XMSS and/or XMSS-MT may comply or be compatible with one or more Internet Engineering Task Force (IETF.RTM.) informational draft Internet notes, e.g., draft draft-irtf-cfrg-xmss-hash-based-signatures-00, titled “XMSS: Extended Hash-Based Signatures, released April 2015, by the Internet Research Task Force, Crypto Forum Research Group of the IETF.RTM. and/or later and/or related versions of this informational draft, such as draft draft-irtf-cfrg-xmss-hash-based-signatures-06, released June 2016.

Winternitz OTS is configured to generate a signature and to verify a received signature utilizing a hash function. Winternitz OTS is further configured to use the private key and, thus, each private key element, sₖᵢ, one time. For example, Winternitz OTS may be configured to apply a hash function to each private key element, mᵢ or N-mᵢ times to generate a signature and to apply the hash function to each received message element N-mᵢ or mᵢ times to generate a corresponding verification signature element. The Merkle many time signature scheme is a hash-based signature scheme that utilizes an OTS and may use a public key more than one time. For example, the Merkle signature scheme may utilize Winternitz OTS as the one-time signature scheme. WOTS+ is configured to utilize a family of hash functions and a chain function.

XMSS, WOTS+ and XMSS-MT are examples of hash-based signature schemes that utilize chain functions. Each chain function is configured to encapsulate a number of calls to a hash function and may further perform additional operations. The number of calls to the hash function included in the chain function may be fixed. Chain functions may improve security of an associated hash-based signature scheme. Hash-based signature balancing, as described herein, may similarly balance chain function operations.

Cryptography circuitry 340 is configured to perform various cryptographic and/or security functions on behalf of the signing device 310. In some embodiments, the cryptography circuitry 340 may be embodied as a cryptographic engine, an independent security co-processor of the signing device 310, a cryptographic accelerator incorporated into the processor(s) 320, or a standalone software/firmware. In some embodiments, the cryptography circuitry 340 may generate and/or utilize various cryptographic keys (e.g., symmetric/asymmetric cryptographic keys) to facilitate encryption, decryption, signing, and/or signature verification. Additionally, in some embodiments, the cryptography circuitry 340 may facilitate to establish a secure connection with remote devices over communication link. It should further be appreciated that, in some embodiments, the cryptography module 340 and/or another module of the first device 310 may establish a trusted execution environment or secure enclave within which a portion of the data described herein may be stored and/or a number of the functions described herein may be performed.

After the signature is generated as described above, the message, M, and signature may then be sent by first device 310, e.g., via communication circuitry 342, to second device 350 via network communication link 390. In an embodiment, the message, M, may not be encrypted prior to transmission. In another embodiment, the message, M, may be encrypted prior to transmission. For example, the message, M, may be encrypted by cryptography circuitry 340 to produce an encrypted message.

Second device 350 may also include one or more processors 360 and a memory 362 to store a public key 364. As described above, the processor(s) 360 may be embodied as any type of processor capable of performing the functions described herein. For example, the processor(s) 360 may be embodied as a single or multi-core processor(s), digital signal processor, microcontroller, or other processor or processing/controlling circuit. Similarly, the memory 362 may be embodied as any type of volatile or non-volatile memory or data storage capable of performing the functions described herein. In operation, the memory 362 may store various data and software used during operation of the second device 350 such as operating systems, applications, programs, libraries, and drivers. The memory 362 is communicatively coupled to the processor(s) 360.

In some examples the public key 364 may be provided to verifier device 350 in a previous exchange. The public key, Pₖ, is configured to contain a number L of public key elements, i.e., pₖ=[pₖ₁, . . . , p_{kL}]. The public key 364 may be stored, for example, to memory 362.

Second device 350 further comprises authentication circuitry 370 which includes hash circuitry 372, signature circuitry, and verification circuitry 376. As described above, hash circuitry 372 is configured to hash (i.e., to apply a hash function to) a message (M) to generate a hash message (m′). Hash functions may include, but are not limited to, a secure hash function, e.g., secure hash algorithms SHA2-256 and/or SHA3-256, etc. SHA2-256 may comply and/or be compatible with Federal Information Processing Standards (FIPS) Publication 180-4, titled: “Secure Hash Standard (SHS)”, published by National Institute of Standards and Technology (NIST) in March 2012, and/or later and/or related versions of this standard. SHA3-256 may comply and/or be compatible with FIPS Publication 202, titled: “SHA-3 Standard: Permutation-Based Hash and Extendable-Output Functions”, published by NIST in August 2015, and/or later and/or related versions of this standard.

In instances in which the second device is the verifying device, authentication circuitry 370 is configured to generate a verification signature based, at least in part, on the signature received from the first device and based, at least in part, on the received message representative (m′). For example, authentication circuitry 370 may configured to perform the same signature operations, i.e., apply the same hash function or chain function as applied by hash circuitry 332 of authentication circuitry 330, to each received message element a number, N-mᵢ (or mᵢ), times to yield a verification message element. Whether a verification signature, i.e., each of the L verification message elements, corresponds to a corresponding public key element, pₖ₁, may then be determined. For example, verification circuitry 370 may be configured to compare each verification message element to the corresponding public key element, pₖᵢ. If each of the verification message element matches the corresponding public key element, pₖᵢ, then the verification corresponds to success. In other words, if all of the verification message elements match the public key elements, pₖ₁, . . . , p_{kL}, then the verification corresponds to success. If any verification message element does not match the corresponding public key element, pₖ₁, then the verification corresponds to failure.

As described in greater detail below, in some examples the authentication circuitry 330 of the first device 310 includes one or more accelerators 338 that cooperate with the hash circuitry 332, signature circuitry 334 and/or verification circuitry 336 to accelerate authentication operations. Similarly, in some examples the authentication circuitry 370 of the second device 310 includes one or more accelerators 378 that cooperate with the hash circuitry 372, signature circuitry 374 and/or verification circuitry 376 to accelerate authentication operations. Examples of accelerators are described in the following paragraphs and with reference to the accompanying drawings.

The various modules of the environment 300 may be embodied as hardware, software, firmware, or a combination thereof. For example, the various modules, circuitry, and other components of the environment 300 may form a portion of, or otherwise be established by, the processor(s) 320 of first device 310 or processor(s) 360 of second device 350, or other hardware components of the devices As such, in some embodiments, one or more of the modules of the environment 300 may be embodied as circuitry or collection of electrical devices (e.g., an authentication circuitry, a cryptography circuitry, a communication circuitry, a signature circuitry, and/or a verification circuitry). Additionally, in some embodiments, one or more of the illustrative modules may form a portion of another module and/or one or more of the illustrative modules may be independent of one another.

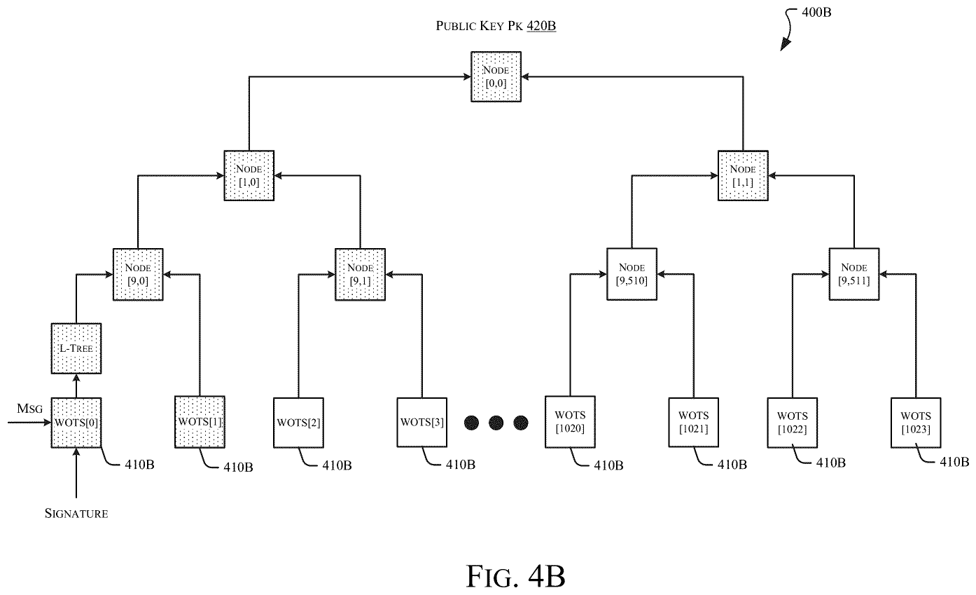

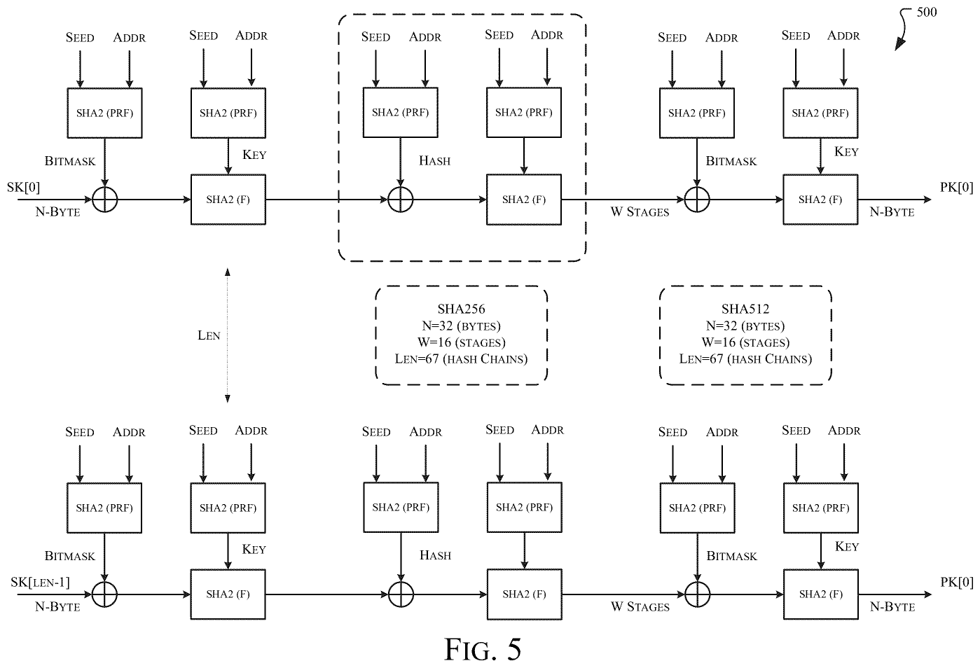

FIG. 4A is a schematic illustration of a Merkle tree structure illustrating signing operations, in accordance with some examples. Referring to FIG. 4A, an XMSS signing operation requires the construction of a Merkle tree 400A using the local public key from each leaf WOTS node 410 to generate a global public key (PK) 420. In some examples the authentication path and the root node value can be computed off-line such that these operations do not limit performance. Each WOTS node 410 has a unique secret key, “sₖ” which is used to sign a message only once. The XMSS signature consists of a signature generated for the input message and an authentication path of intermediate tree nodes to construct the root of the Merkle tree.

FIG. 4B is a schematic illustration of a Merkle tree structure 400B during verification, in accordance with some examples. During verification, the input message and signature are used to compute the local public key 420B of the WOTS node, which is further used to compute the tree root value using the authentication path. A successful verification will match the computed tree root value to the public key PK shared by the signing entity. The WOTS and L-Tree operations constitute on a significant portion of XMSS sign/verify latency respectively, thus defining the overall performance of the authentication system. Described herein are various pre-computation techniques which may be implemented to speed-up WOTS and L-Tree operations, thereby improving XMSS performance. The techniques are applicable to the other hash options and scale well for both software and hardware implementations.

FIG. 5 is a schematic illustration of a compute blocks in an architecture 500 to implement a signature algorithm, in accordance with some examples. Referring to FIG. 5, the WOTS+ operation involves 67 parallel chains of 16 SHA2-256 HASH functions, each with the secret key sₖ [66:0] as input. Each HASH operation in the chain consists of 2 pseudo-random functions (PRF) using SHA2-256 to generate a bitmask and a key. The bitmask is XOR-ed with the previous hash and concatenated with the key as input message to a 3rd SHA2-256 hash operation. The 67×32-byte WOTS public key pk[66:0] is generated by hashing secret key sₖ across the 67 hash chains.

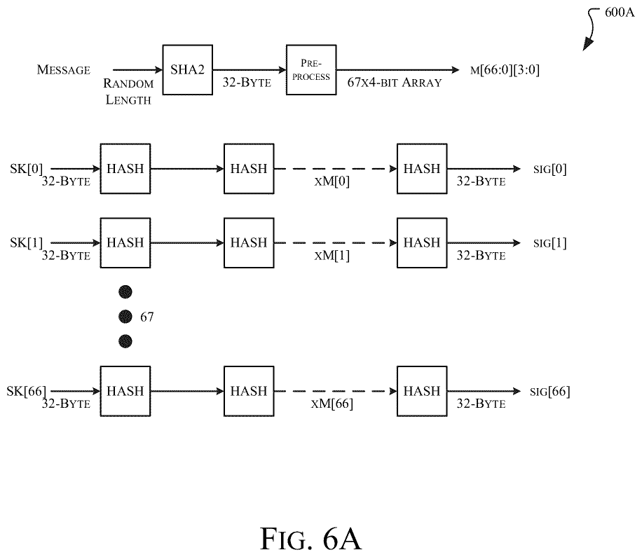

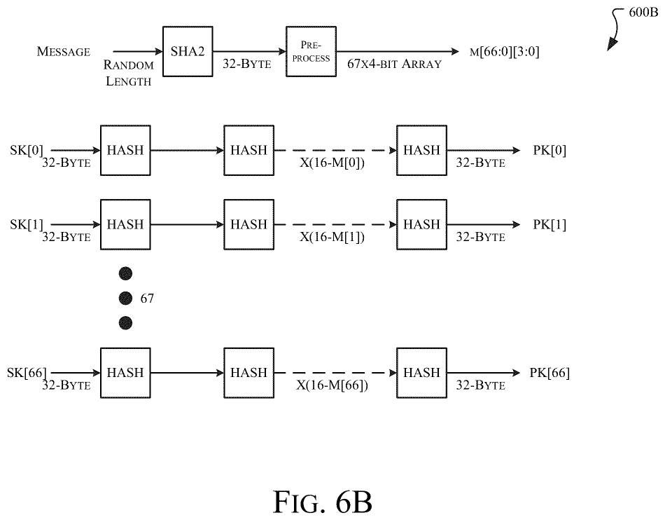

FIG. 6A is a schematic illustration of a compute blocks in an architecture 600A to implement signature generation in a signature algorithm, in accordance with some examples. As illustrated in FIG. 6A, for message signing, the input message is hashed and pre-processed to compute a 67×4-bit value, which is used as an index to choose an intermediate hash value in each chain.

FIG. 6B is a schematic illustration of a compute blocks in an architecture 600B to implement signature verification in a verification algorithm, in accordance with some examples. Referring to FIG. 6B, during verification, the message is again hashed to compute the signature indices and compute the remaining HASH operations in each chain to compute the WOTS public key pk. This value and the authentication path are used to compute the root of the Merkle tree and compare with the shared public key PK to verify the message.

### Post-Quantum Lattice-Based Signature Latency Reduction

Various electronic devices use cryptography algorithms (e.g., RSA, EC-DSA) to verify authenticity of hardware and/or firmware at boot time, or upon request. As described above, these cryptography algorithms are expected to be broken by quantum computers. Crystal-Dilithium is being considered by NIST as a finalist for Digital Signature (DS) schemes in post-quantum cryptography standardization.

Subject matter described herein addresses primarily lattice-based digital signature algorithms based on the Fiat-Shamir heuristic. In these signing algorithms, the signing key usually contains a short random element s. To sign, the algorithm first commits to a large uniformly random mask γ, receives a random challenge c, computes z=y+c⊙s, and finally returns (c,z) as part of the signature.

Since simply returning z may leak information about the secret signing key s, such digital signature algorithms usually use a technique known as rejection sampling to remove information about the secret s from the distribution of z. This technique involves probabilistically discarding certain random samples to coerce a first distribution into a second distribution. In this case, the signing algorithm will compare the norm of z against a pre-determined threshold and discard any samples which fall outside of the threshold. This results in a uniform distribution of signature candidates (z) being output by the algorithm.

Since the rejection sampling technique will probabilistically discard some of the generated signatures, the core part of the signing algorithm must be run a random number of times until a signature passes the rejection sampling step. These rejections can quickly add to the expected latency of the signing algorithm if the probability of rejection is high.

In CRYSTALS-Dilithium level 3, the expected number of repetitions due to rejection sampling is about 5.1. This results in an expected number of approximately 1,500,000 CPU cycles to produce a signature. By contrast, an Elliptic Curve Digital Signature Algorithm (ECDSA) can produce a signature in approximately 300,000 CPU cycles. Thus, the number of repetitions required by the rejection sampling routing presents a material source of latency in computing digital signatures.

Subject matter described herein addresses these and other issues by providing techniques to implement post-quantum lattice-based signature latency reduction. In some examples, novel techniques for analyzing the security of the rejection sampling step are implemented. In some examples the techniques measure a statistical distance between the marginal distribution of a single coordinate of z (the signature) and a uniform distribution over the same interval. This difference may be used to determine new thresholds of the rejection sampling steps of lattice-based digital signature algorithms including CRYSTALS-Dilithium, qTesla, and MPSign. This technique helps reduce the probability of rejection, thus improving the latency of the signing algorithm while preserving the overall security.

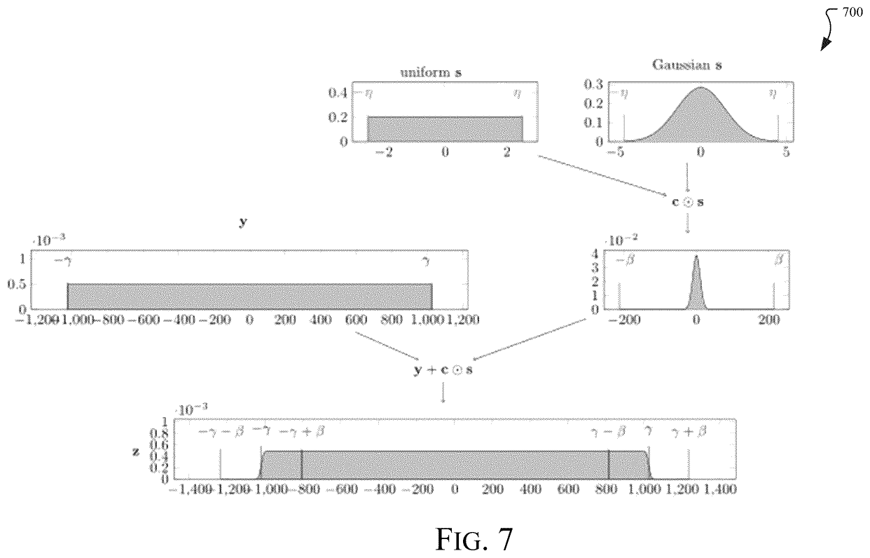

FIG. 7 is a schematic illustration of distributions 700 of components of a digital signature, in accordance with some examples. Referring to FIG. 7, in some examples a single rejection sampling step in one of the lattice-based signing algorithms may be examined in isolation. As illustrated in FIG. 7, there are four random variables: s which is part of the signing key and drawn from either a uniform (CRYSTALS-Dilithium) or a discrete Gaussian (qTesla, MPSign) distribution, c often referred to as the random challenge comes from a sparse set of polynomials where each coordinate comes from the set {−1, 0, +1} and exactly T coefficients are non-zero, y which is the masking randomness drawn from a large uniform distribution, and z: =y+c⊙s where ⊙ is the appropriate multiplication operation from the ring in the case of CRYSTALS-Dilithium and qTesla and the middle-product operation in MPSign. In some examples, a rejection sampling algorithm evaluates the value of a signature candidate (z) and reject if ∥z∥∞≥γ−β, otherwise z is output as part of the digital signature.

The parameter β is chosen in different manners in different digital signature techniques. In CRYSTALS-Dilithium, qTesla, and MPSign, the parameter β is chosen by first determining a bound (η) on the distribution of the parameter s. In the case of CRYSTALS-Dilithium, this is a simple enough matter as by definition s is drawn from a bounded uniform distribution. In the case of qTesla and MPSign, the parameter s is instead drawn from a discrete Gaussian distribution which may be unbounded. In some examples a Gaussian tail-cut lemma may be used to determine a practical bound on this distribution. When an s drawn from such a bounded distribution is multiplied by a challenge polynomial c of weight τ, the marginal distribution of each coordinate comes from a distribution of bound β=τ·η. After adding the masking randomness γ bounded by γ, a distribution is obtained in which the center region between −γ+β and γ−β is perfectly uniform. By rejecting any samples which lie outside of this center region, what remains is a uniform variable z over the interval (−γ+β,γ−β).

By using this value of β, which defines the maximum possible value of a single coefficient in a signature, we can measure the statistical distance between z and a uniform variable over the same interval is under a threshold that is close to zero, which equates to perfect statistical hiding of the signing key. The parameter β, in other words, represents the threshold of the rejection sampling. However, a statistical distance of ≤2^{-λ} would be sufficient for λ-bit security. Thus, the region from −γ+β to γ−β needs to be very close to uniform. Note that the parameter λ represents the target number of bits of security. The diagrams in 700 are drawn using real parameters used in MPSign. Referring to FIG. 7, one may see that the graph of the parameter (z) appears to be uniform almost all the way up to −γ and γ.

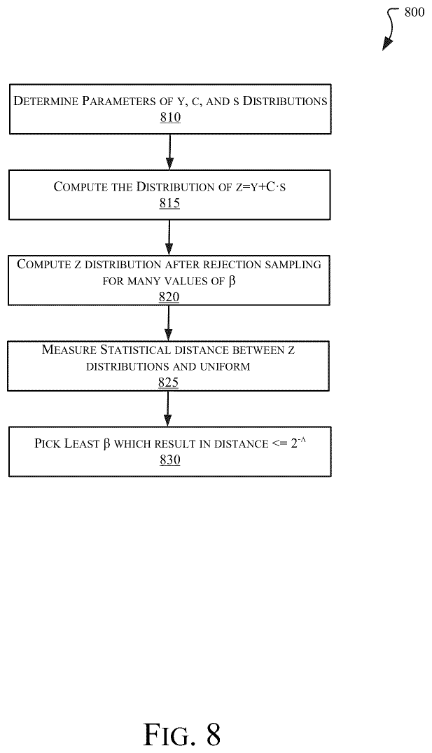

FIG. 8. is a flowchart illustrating operations in a method 800 to implement post-quantum lattice-based signature latency reduction, in accordance with some examples. Referring to FIG. 8, at operation 810 the parameters of the distributions of the variables y, c, and s are determined. In some examples, CRYSTALS-Dilithium at security level 3 defines this distribution parameters by variables η=4, −τ=49, γ=2¹⁹, and n_{z}=28×5.

At operation 815, the distribution of potential signatures z:=γ+c⊙s are computed. In some examples, . . . it is computed through computing the probability density function (PDF) on z.

At operation 820 the distribution of the values of the parameter z are computed after rejection sampling for values of the parameter β. In some examples, rejection sampling may be performed using a probability density function (PDF) computation after rejection of samples from z with a specific value of β.

At operation 825 a statistical distance between the z distribution computed in operation 820 and a uniform distribution are computed. In some examples, . . . it is computed through following formula.

$$\begin{matrix}λ = - {log}_{2} Δ ( {Z}_{S , τ , γ , β} , {U}_{γ - β} ) \\ = - {log}_{2} \frac{1}{2} {\sum }_{x = - γ + β + 1}^{γ - β - 1} \vert {PDF}_{{Z}_{S , τ , γ , β}^{′}} ( x ) - \frac{1}{2 γ - 2 β - 1} \vert\end{matrix}$$

At operation 830 a value of the parameter β is selected that results in a statistical distance that is less than or equal to 2^{-λ}. In some examples, . . . CRISTALS-Dilithium with level 3 security the parameter β=196 as defined in the NIST spec vs β=161 to provide same security of 2⁸¹ on quantum computers.

Table 1 presents results of this technique. By analyzing the rejection sampling condition mathematically, an expected value for the number of repetitions due to rejection sampling can be computed for each of these algorithm. Comparing these values both before and after the technique indicates how an amount of latency reduction to expect on average when running the algorithms on hardware.

TABLE 1

| Algorithm | | Spec β vs | Expected | Signing |
|---|---|---|---|---|
| Family | Algorithm | Current | Repeats | Latency |
| CRYSTALS- | Dilithium2 | 78 vs 70 | −6.027% | −5.988% |
| Dilithium | Dilithium3 | 196 vs 161 | −8.199% | −5.191% |
| | Dilithium5 | 120 vs 112 | −2.730% | −1.450% |
| qTesla | qTesla-p-I | 554 vs 330 | −35.460% | −28.152% |
| | qTesla-p-III | 901 vs 541 | −75.542% | −23.146% |
| MPSign | MPSign 89-bit | 213 vs 98 | −44.613% | |
| | MPSign 143-bit | 213 vs 133 | −34.102% | |

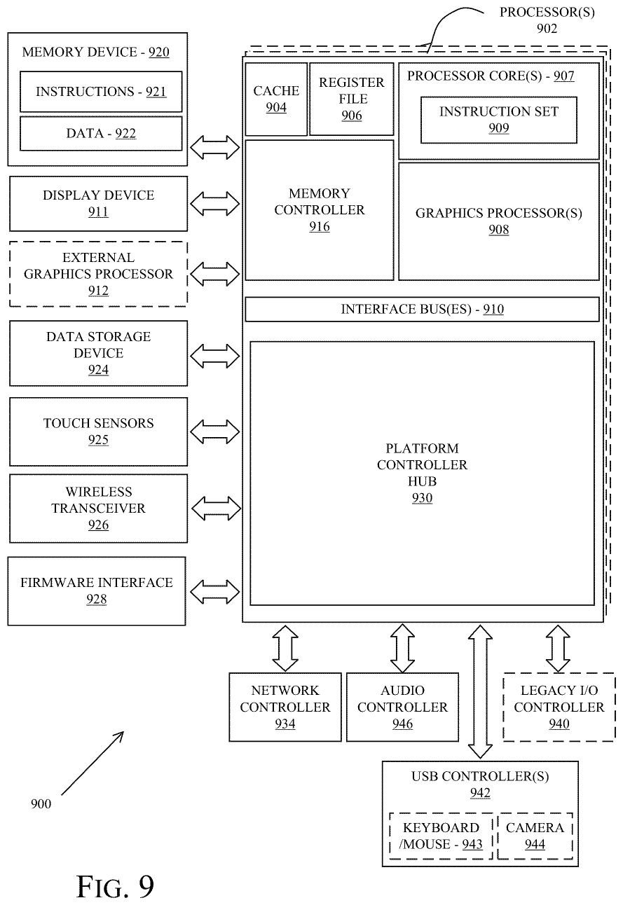

FIG. 9 illustrates an embodiment of an exemplary computing architecture that may be suitable for implementing various embodiments as previously described. In various embodiments, the computing architecture 900 may comprise or be implemented as part of an electronic device. In some embodiments, the computing architecture 900 may be representative, for example of a computer system that implements one or more components of the operating environments described above. In some embodiments, computing architecture 900 may be representative of one or more portions or components of a DNN training system that implement one or more techniques described herein. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 900. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 900 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 900.

As shown in FIG. 9, the computing architecture 900 includes one or more processors 902 and one or more graphics processors 908, and may be a single processor desktop system, a multiprocessor workstation system, or a server system having a large number of processors 902 or processor cores 907. In on embodiment, the system 900 is a processing platform incorporated within a system-on-a-chip (SoC or SOC) integrated circuit for use in mobile, handheld, or embedded devices.

An embodiment of system 900 can include, or be incorporated within a server-based gaming platform, a game console, including a game and media console, a mobile gaming console, a handheld game console, or an online game console. In some embodiments system 900 is a mobile phone, smart phone, tablet computing device or mobile Internet device. Data processing system 900 can also include, couple with, or be integrated within a wearable device, such as a smart watch wearable device, smart eyewear device, augmented reality device, or virtual reality device. In some embodiments, data processing system 900 is a television or set top box device having one or more processors 902 and a graphical interface generated by one or more graphics processors 908.

In some embodiments, the one or more processors 902 each include one or more processor cores 907 to process instructions which, when executed, perform operations for system and user software. In some embodiments, each of the one or more processor cores 907 is configured to process a specific instruction set 909. In some embodiments, instruction set 909 may facilitate Complex Instruction Set Computing (CISC), Reduced Instruction Set Computing (RISC), or computing via a Very Long Instruction Word (VLIW). Multiple processor cores 907 may each process a different instruction set 909, which may include instructions to facilitate the emulation of other instruction sets. Processor core 907 may also include other processing devices, such a Digital Signal Processor (DSP).

In some embodiments, the processor 902 includes cache memory 904. Depending on the architecture, the processor 902 can have a single internal cache or multiple levels of internal cache. In some embodiments, the cache memory is shared among various components of the processor 902. In some embodiments, the processor 902 also uses an external cache (e.g., a Level-3 (L3) cache or Last Level Cache (LLC)) (not shown), which may be shared among processor cores 907 using known cache coherency techniques. A register file 906 is additionally included in processor 902 which may include different types of registers for storing different types of data (e.g., integer registers, floating point registers, status registers, and an instruction pointer register). Some registers may be general-purpose registers, while other registers may be specific to the design of the processor 902.

In some embodiments, one or more processor(s) 902 are coupled with one or more interface bus(es) 910 to transmit communication signals such as address, data, or control signals between processor 902 and other components in the system. The interface bus 910, in one embodiment, can be a processor bus, such as a version of the Direct Media Interface (DMI) bus. However, processor busses are not limited to the DMI bus, and may include one or more Peripheral Component Interconnect buses (e.g., PCI, PCI Express), memory busses, or other types of interface busses. In one embodiment the processor(s) 902 include an integrated memory controller 916 and a platform controller hub 930. The memory controller 916 facilitates communication between a memory device and other components of the system 900, while the platform controller hub (PCH) 930 provides connections to I/O devices via a local I/O bus.

Memory device 920 can be a dynamic random-access memory (DRAM) device, a static random-access memory (SRAM) device, flash memory device, phase-change memory device, or some other memory device having suitable performance to serve as process memory. In one embodiment the memory device 920 can operate as system memory for the system 900, to store data 922 and instructions 921 for use when the one or more processors 902 executes an application or process. Memory controller hub 916 also couples with an optional external graphics processor 912, which may communicate with the one or more graphics processors 908 in processors 902 to perform graphics and media operations. In some embodiments a display device 911 can connect to the processor(s) 902. The display device 911 can be one or more of an internal display device, as in a mobile electronic device or a laptop device or an external display device attached via a display interface (e.g., DisplayPort, etc.). In one embodiment the display device 911 can be a head mounted display (HMD) such as a stereoscopic display device for use in virtual reality (VR) applications or augmented reality (AR) applications.

In some embodiments the platform controller hub 930 enables peripherals to connect to memory device 920 and processor 902 via a high-speed I/O bus. The I/O peripherals include, but are not limited to, an audio controller 946, a network controller 934, a firmware interface 928, a wireless transceiver 926, touch sensors 925, a data storage device 924 (e.g., hard disk drive, flash memory, etc.). The data storage device 924 can connect via a storage interface (e.g., SATA) or via a peripheral bus, such as a Peripheral Component Interconnect bus (e.g., PCI, PCI Express). The touch sensors 925 can include touch screen sensors, pressure sensors, or fingerprint sensors. The wireless transceiver 926 can be a Wi-Fi transceiver, a Bluetooth transceiver, or a mobile network transceiver such as a 3G, 4G, or Long Term Evolution (LTE) transceiver. The firmware interface 928 enables communication with system firmware, and can be, for example, a unified extensible firmware interface (UEFI). The network controller 934 can enable a network connection to a wired network. In some embodiments, a high-performance network controller (not shown) couples with the interface bus 910. The audio controller 946, in one embodiment, is a multi-channel high definition audio controller. In one embodiment the system 900 includes an optional legacy I/O controller 940 for coupling legacy (e.g., Personal System 2 (PS/2)) devices to the system. The platform controller hub 930 can also connect to one or more Universal Serial Bus (USB) controllers 942 connect input devices, such as keyboard and mouse 943 combinations, a camera 944, or other USB input devices.

The following pertains to further examples.

Example 1 is an apparatus, comprising processing circuitry to measure a statistical distance between a marginal distribution of a coordinate of a potential signature (z) over a first interval and a uniform distribution over the first interval; and use the statistical distance to determine one or more thresholds of a rejection sampling operation in a lattice-based digital signature algorithm.

In Example 2, the subject matter of Example 1 can optionally include processing circuitry to determine a first set of parameters of a distribution of a masking randomness variable in the lattice-based digital signature algorithm over the first interval; determine a second set of parameters of a distribution of a random challenge variable (c) in the lattice-based digital signature algorithm over the first interval; and determine a third set of parameters of a distribution of a portion of a signing key (s) in the lattice-based digital signature algorithm over the first interval.

In Example 3, the subject matter of any one of Examples 1-2 can optionally include processing circuitry to determine a distribution of a value of the potential signature (z) in the lattice-based digital signature algorithm over the first interval.

In Example 4, the subject matter of any one of Examples 1-3 can optionally include processing circuitry to determine a portion of the distribution of the potential signature (z) in the lattice-based digital signature algorithm over the first interval in which the statistical distance between a marginal distribution of a coordinate of a potential signature (z) over a first interval and a uniform distribution over the first interval is less than a threshold value near zero.

In Example 5, the subject matter of any one of Examples 1-4 can optionally include processing circuitry to reject one or more potential signature components in the lattice-based digital signature algorithm that are outside the portion of the distribution of the potential signature (z) in the lattice-based digital signature algorithm over the first interval in which the statistical distance between a marginal distribution of a coordinate of a potential signature (z) over a first interval and a uniform distribution over the first interval is less than a threshold value near zero.

In Example 6, the subject matter of any one of Examples 1-5 can optionally include processing circuitry to perform rejection sampling using a probability density function (PDF) computation after rejection of samples from z with a specific value of β.

In Example 7, the subject matter of any one of Examples 1-6 can optionally include processing circuitry to select a value of the parameter β that results in a statistical distance that is less than or equal to 2^{-λ}.

In Example 8, is a method comprising measuring a statistical distance between a marginal distribution of a coordinate of a potential signature (z) over a first interval and a uniform distribution over the first interval; and using the statistical distance to determine one or more thresholds of a rejection sampling operation in a lattice-based digital signature algorithm.

In Example 9, the subject matter of Example 8 can optionally include determining a first set of parameters of a distribution of a masking randomness variable in the lattice-based digital signature algorithm over the first interval; determining a second set of parameters of a distribution of a random challenge variable (c) in the lattice-based digital signature algorithm over the first interval; and determining a third set of parameters of a distribution of a portion of a signing key (s) in the lattice-based digital signature algorithm over the first interval.

In Example 10, the subject matter of any one of Examples 8-9 further comprising determining a distribution of a value of the potential signature (z) in the lattice-based digital signature algorithm over the first interval.

In Example 11, the subject matter of any one of Examples 8-10 further comprising determining a portion of the distribution of the potential signature (z) in the lattice-based digital signature algorithm over the first interval in which the statistical distance between a marginal distribution of a coordinate of a potential signature (z) over a first interval and a uniform distribution over the first interval is less than a threshold value near zero.

In Example 12, the subject matter of any one of Examples 8-11 further comprising rejecting one or more potential signature components in the lattice-based digital signature algorithm that are outside the portion of the distribution of the potential signature (z) in the lattice-based digital signature algorithm over the first interval in which the statistical distance between a marginal distribution of a coordinate of a potential signature (z) over a first interval and a uniform distribution over the first interval is less than a threshold value near zero.

In Example 13, the subject matter of any one of Examples 8-12 can optionally include performing rejection sampling using a probability density function (PDF) computation after rejection of samples from z with a specific value of β.

In Example 14, the subject matter of any one of Examples 8-13 can optionally include selecting a value of the parameter β that results in a statistical distance that is less than or equal to 2^{-λ}.

Example 15 is a non-transitory computer-readable medium comprising instructions which, when executed by a processor, configure the processor to measure a statistical distance between a marginal distribution of a coordinate of a potential signature (z) over a first interval and a uniform distribution over the first interval; and use the statistical distance to determine one or more thresholds of a rejection sampling operation in a lattice-based digital signature algorithm.

In Example 16, the subject matter of Example 15 can optionally include instructions which, when executed by the processor, configure the processor to determine a first set of parameters of a distribution of a masking randomness variable in the lattice-based digital signature algorithm over the first interval; determine a second set of parameters of a distribution of a random challenge variable (c) in the lattice-based digital signature algorithm over the first interval; and determine a third set of parameters of a distribution of a portion of a signing key (s) in the lattice-based digital signature algorithm over the first interval.

In Example 17, the subject matter of any one of Examples 15-16 can optionally include further comprising instructions which, when executed by the processor, configure the processor to determine a distribution of a value of the potential signature (z) in the lattice-based digital signature algorithm over the first interval.

In Example 18, the subject matter of any one of Examples 15-17 can optionally include further comprising instructions which, when executed by the processor, configure the processor to determine a portion of the distribution of the potential signature (z) in the lattice-based digital signature algorithm over the first interval in which the statistical distance between a marginal distribution of a coordinate of a potential signature (z) over a first interval and a uniform distribution over the first interval is less than a threshold value near zero.

In Example 19, the subject matter of any one of Examples 15-18 can optionally include further comprising instructions which, when executed by the processor, configure the processor to reject one or more potential signature components in the lattice-based digital signature algorithm that are outside the portion of the distribution of the potential signature (z) in the lattice-based digital signature algorithm over the first interval in which the statistical distance between a marginal distribution of a coordinate of a potential signature (z) over a first interval and a uniform distribution over the first interval is less than a threshold value near zero.

In Example 20, the subject matter of any one of Examples 15-19 can optionally include instructions to perform rejection sampling using a probability density function (PDF) computation after rejection of samples from z with a specific value of β.

In Example 21, the subject matter of any one of Examples 15-20 can optionally include instructions to select a value of the parameter β that results in a statistical distance that is less than or equal to 2^{-λ}.

The above Detailed Description includes references to the accompanying drawings, which form a part of the Detailed Description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In addition, “a set of” includes one or more elements. In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” “third,” etc. are used merely as labels, and are not intended to suggest a numerical order for their objects.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and examples are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and examples are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and examples are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular examples, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one example” or “some examples” means that a particular feature, structure, or characteristic described in connection with the example is included in at least an implementation. The appearances of the phrase “in one example” in various places in the specification may or may not be all referring to the same example.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

Although examples have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising processing circuitry to:
measure a statistical distance between a marginal distribution of a coordinate of a potential signature (z) over a first interval and a uniform distribution over the first interval; and
use the statistical distance to determine one or more thresholds of a rejection sampling operation in a lattice-based digital signature algorithm.

2. The apparatus of claim 1, further comprising processing circuitry to:
determine a first set of parameters of a distribution of a masking randomness variable in the lattice-based digital signature algorithm over the first interval;
determine a second set of parameters of a distribution of a random challenge variable (c) in the lattice-based digital signature algorithm over the first interval; and
determine a third set of parameters of a distribution of a portion of a signing key (s) in the lattice-based digital signature algorithm over the first interval.

3. The apparatus of claim 1, further comprising processing circuitry to:
determine a distribution of a value of the potential signature (z) in the lattice-based digital signature algorithm over the first interval.

4. The apparatus of claim 1, further comprising processing circuitry to:
determine a portion of the distribution of the potential signature (z) in the lattice-based digital signature algorithm over the first interval in which the statistical distance between a marginal distribution of a coordinate of a potential signature (z) over a first interval and a uniform distribution over the first interval is less than a threshold value near zero.

5. The apparatus of claim 1, further comprising processing circuitry to:
reject one or more potential signature components in the lattice-based digital signature algorithm that are outside the portion of the distribution of the potential signature (z) in the lattice-based digital signature algorithm over the first interval in which the statistical distance between a marginal distribution of a coordinate of a potential signature (z) over a first interval and a uniform distribution over the first interval is less than a threshold value near zero.

6. The apparatus of claim 5, the processing circuitry to perform rejection sampling using a probability density function (PDF) computation after rejection of samples from z with a specific value of β.

7. The apparatus of claim 6, the processing circuitry to select a value of the parameter β that results in a statistical distance that is less than or equal to 2^{-λ}.

8. A method, comprising:
measuring a statistical distance between a marginal distribution of a coordinate of a potential signature (z) over a first interval and a uniform distribution over the first interval; and
using the statistical distance to determine one or more thresholds of a rejection sampling operation in a lattice-based digital signature algorithm.

9. The method of claim 8, further comprising:
determining a first set of parameters of a distribution of a masking randomness variable in the lattice-based digital signature algorithm over the first interval;
determining a second set of parameters of a distribution of a random challenge variable (c) in the lattice-based digital signature algorithm over the first interval; and
determining a third set of parameters of a distribution of a portion of a signing key (s) in the lattice-based digital signature algorithm over the first interval.

10. The method of claim 8, further comprising:
determining a distribution of a value of the potential signature (z) in the lattice-based digital signature algorithm over the first interval.

11. The method of claim 8, further comprising:
determine a portion of the distribution of the potential signature (z) in the lattice-based digital signature algorithm over the first interval in which the statistical distance between a marginal distribution of a coordinate of a potential signature (z) over a first interval and a uniform distribution over the first interval is less than a threshold value near zero.

12. The method of claim 11, further comprising:
reject one or more potential signature components in the lattice-based digital signature algorithm that are outside the portion of the distribution of the potential signature (z) in the lattice-based digital signature algorithm over the first interval in which the statistical distance between a marginal distribution of a coordinate of a potential signature (z) over a first interval and a uniform distribution over the first interval is less than a threshold value near zero.

13. The method of claim 12, further comprising performing rejection sampling using a probability density function (PDF) computation after rejection of samples from z with a specific value of β.

14. The method of claim 8, further comprising select a value of the parameter β that results in a statistical distance that is less than or equal to 2^{-λ}.

15. A non-transitory computer-readable medium comprising instructions which, when executed by a processor, configure the processor to:
measure a statistical distance between a marginal distribution of a coordinate of a potential signature (z) over a first interval and a uniform distribution over the first interval; and
use the statistical distance to determine one or more thresholds of a rejection sampling operation in a lattice-based digital signature algorithm.

16. The non-transitory computer-readable medium of claim 15, further comprising instructions which, when executed by the processor, configure the processor to
determine a first set of parameters of a distribution of a masking randomness variable in the lattice-based digital signature algorithm over the first interval;
determine a second set of parameters of a distribution of a random challenge variable (c) in the lattice-based digital signature algorithm over the first interval; and
determine a third set of parameters of a distribution of a portion of a signing key (s) in the lattice-based digital signature algorithm over the first interval.

17. The non-transitory computer-readable medium of claim 16, further comprising instructions which, when executed by the processor, configure the processor to:
determine a distribution of a value of the potential signature (z) in the lattice-based digital signature algorithm over the first interval.

18. The non-transitory computer-readable medium of claim 15, further comprising instructions which, when executed by the processor, configure the processor to:
determine a portion of the distribution of the potential signature (z) in the lattice-based digital signature algorithm over the first interval in which the statistical distance between a marginal distribution of a coordinate of a potential signature (z) over a first interval and a uniform distribution over the first interval is less than a threshold value near zero.

19. The non-transitory computer-readable medium of claim 18, further comprising instructions which, when executed by the processor, configure the processor to:
reject one or more potential signature components in the lattice-based digital signature algorithm that are outside the portion of the distribution of the potential signature (z) in the lattice-based digital signature algorithm over the first interval in which the statistical distance between a marginal distribution of a coordinate of a potential signature (z) over a first interval and a uniform distribution over the first interval is less than a threshold value near zero.

20. The non-transitory computer-readable medium of claim 19, further comprising instructions which, when executed by the processor, configure the processor to perform rejection sampling using a probability density function (PDF) computation after rejection of samples from z with a specific value of β.

21. The non-transitory computer-readable medium of claim 15, further comprising instructions which, when executed by the processor, configure the processor to select a value of the parameter β that results in a statistical distance that is less than or equal to 2^{-λ}.
